(19) United States
(12) Patent Application Publication
(10) Pub. No.: US 2006/0164155 A1
(43) Pub. Date: Jul. 27, 2006

(54) Low-ripple boosted voltage generator

(75) Inventors: Giancarlo Ragone, Roccella Ionica (IT); Miriam Sangalli, Carugate (IT); Rino Micheloni, Turate (IT)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignees: STMicroelectronics S.r.l., Agrate Brianza (IT); Hynix Semiconductor Inc., Ichon-si (KR)

(21) Appl. No.: 11/323,937

(22) Filed: Dec. 30, 2005

(30) Foreign Application Priority Data
Jan. 3, 2005 (EP) 05425001.4

(51) Int. Cl. G05F 1/10

(52) U.S. Cl. 327/536

(57) ABSTRACT

The output voltage ripple of a single stage or a multi-stage charge pump may be significantly reduced by introducing in the voltage generator a cascode connected output transistor. In operation, this output transistor may be in a conduction state and may be controlled with a voltage having a smaller ripple than the voltage output by the charge pump.

### FIELD OF THE INVENTION

The invention relates to boosted voltage generators, and, more particularly, to a boosted voltage generator with a reduced peak-to-peak ripple.

### BACKGROUND OF THE INVENTION

Charge pumps are widely used for generating a voltage larger than the available supply voltage. These generators are used, for example, in FLASH memory devices for reading or writing memory cells, or also for powering certain electronic circuits at a specified boosted voltage.

Typically, charge pumps include a certain number N of stages connected in cascade and the output voltage V_{OUT} generated by the last stage is a multiple of the supply voltage V_{dd} according to the following equations:
V_{OUT}=(N+1)·V_{dd} or V_{OUT}=−N·V_{dd}
depending on whether the output voltage is positive or negative. Therefore, the number of stages N of a multi-stage charge pump is established as a function of the voltage to be generated.

Commonly, the supply voltage is not constant, but varies in a certain range. To generate a constant voltage V_{OUT}, the charge pump may be provided with a regulation circuit of its output voltage. This regulation circuit compares the output voltage V_{OUT} with a reference voltage and stops switching the stages of the charge pump when the output voltage crosses the reference voltage.

The output voltage so generated is affected by a relevant ripple in correspondence with the nominal output voltage of the charge pump. This ripple, that might even be 1V peak-to-peak in value maybe a significant problem in multi-level FLASH memory devices, and may lead to erroneous operation. Indeed, in multi-level memory devices, a maximum ripple of only a few tens of millivolts is allowed.

Charge pumps are also used for powering linear voltage regulators with a controlled voltage. A ripple of this controlled voltage reduces the precision of voltage regulators particularly when the powered regulators do not have a relatively large PSRR (Power Supply Rejection Ratio).

### SUMMARY OF THE INVENTION

An object of the invention is to provide a voltage generator that may generate a boosted voltage with a reduced ripple and a method that may reduce the ripple of a boosted voltage.

According to the invention, the output voltage ripple of a single stage or a multi-stage charge pump may significantly be reduced by introducing in the voltage generator a cascode connected output transistor. In operation, this output transistor may always be in a conduction state and may be controlled with a voltage having a smaller ripple than the voltage output by the charge pump.

More precisely, this invention provides a method that may reduce the ripple of a boosted voltage and a relative generator of a boosted voltage, and may comprise a charge pump generating a controlled voltage at the output of the last stage of the charge pump. The generator may generate a boosted voltage with a relatively small ripple by virtue of a cascode connected output transistor, and the current terminals of which may be connected to the output of a stage of the charge pump and to an output node of the generator, respectively, and may have a control node coupled to a voltage, less corrupted by ripple than the controlled voltage, that may maintain the output transistor in a conduction state.

### BRIEF DESCRIPTION OF THE DRAWINGS

The various features and advantages of the invention will be even more evident through a detailed description of several embodiments referring to the attached drawings, wherein:

FIG. 1 depicts a first embodiment of a generator in accordance with the invention;

FIG. 2 depicts one embodiment of a stage of the multi-stage charge pump of the generator of FIG. 1;

FIG. 3 depicts a voltage dividing low-pass filter in accordance with the invention;

FIG. 4 is a low-pass filter of the control voltage of the output cascode connected transistor of FIG. 1;

FIG. 5 depicts a second embodiment of the generator in accordance with the invention;

FIG. 6 depicts a third embodiment of the generator in accordance with the invention; and

FIG. 7 depicts sample time diagrams of the main voltages of the generator of FIG. 1.

### DETAILED DESCRIPTION OF THE PREFERRED EMBODIMENTS

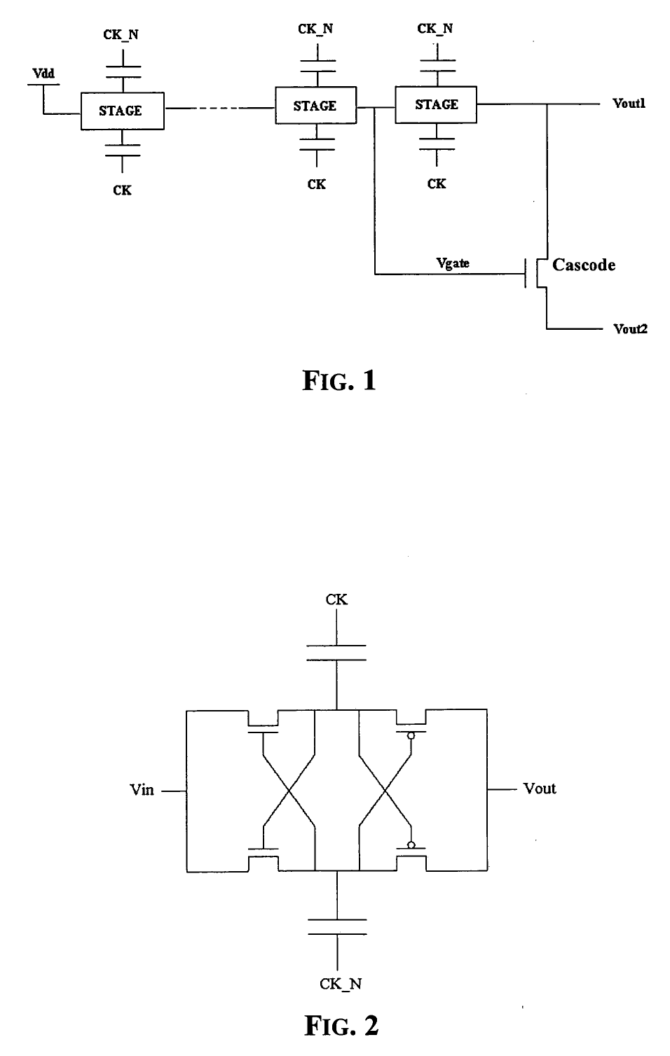

A first architecture of a boosted voltage generator is depicted in FIG. 1. In practice, it includes a multi-stage charge pump and of a cascode connected output transistor CASCODE between the output of the charge pump and the output node of the generator of the boosted voltage Vout2. According to a method aspect the ripple of the boosted voltage is reduced by controlling the output transistor CASCODE with a voltage Vgate affected by a ripple smaller than that of the controlled voltage Vout1 output by the charge pump, and such keeps the output transistor CASCODE in a conduction state.

The generator is described referring to the case in which the cascode connected output transistor is a MOS transistor, but the same considerations apply with the necessary changes having been made for a BJT transistor. Preferably the charge pump is a multi-stage charge pump and the voltage Vgate is generated by any common node between two stages of the multi-stage charge pump.

If the charge pump generates a positive voltage, the output transistor CASCODE comprises an N-channel transistor, and, in the opposite case, a P-channel transistor. In so doing, the transistor never disconnects a supplied load from the charge pump, but simply acts to reduce the ripple of the controlled voltage generated by the charge pump. Indeed, the boosted voltage Vout2 is tied to the control voltage Vgate according to the following equation:
Vout2=Vgate−Vth.

Therefore, the cascode connected output transistor CASCODE effectively reduces the ripple of the generated boosted voltage Vout2 because, when the controlled voltage Vout1 (that is the drain potential) increases, the gate voltage remains substantially constant, and so does the boosted voltage Vout2. Preferably, the control voltage of the output transistor CASCODE is the voltage on the connection node between the last and the before last stage of the charge pump. A boosted voltage generator in which the control node of the output transistor is connected to any other common node of two consecutive stages of the multi-stage charge pump is less convenient than the embodiment depicted in FIG. 1, if the largest possible boosted voltage Vout2 is to be generated.

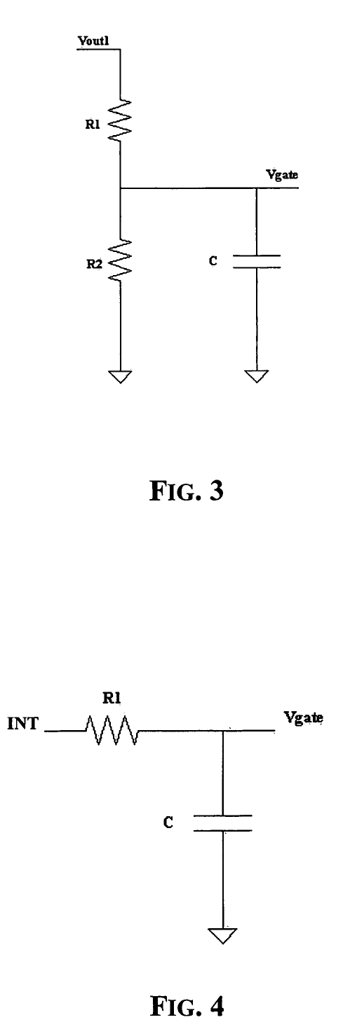

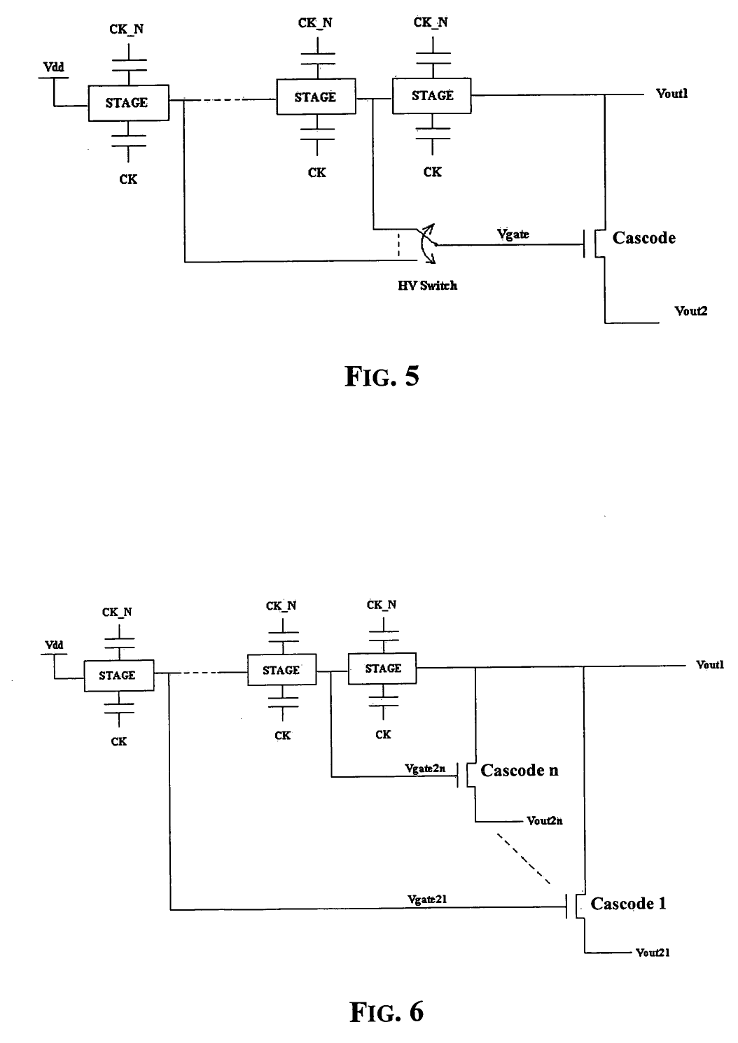

If each stage of the charge pump is a voltage doubler, as depicted in FIG. 2, the control node of the cascode connected transistor may be conveniently connected directly to a common node between two adjacent stages of the charge pump, because the voltage ripple is relatively small. Otherwise, it is preferable to filter this voltage with a low pass filter such that shown in FIG. 4.

As an alternative, the control voltage Vgate of this output transistor CASCODE may be generated by filtering the controlled voltage Vout1 of the charge pump with a voltage dividing low-pass filter of FIG. 3. In this particular case, the generator may even be realized with a single-stage charge pump. Indeed, a multi-stage charge pump is needed only when the control terminal of the cascode transistor is connected to a common node between two consecutive stages of the charge pump.

If the transistor is symmetrical, the output node of the generator may be the drain or the source terminal of the transistor. By contrast, if the transistor is asymmetrical, the output node of the generator is the source or the drain terminal depending on whether a NMOS or a PMOS is used, respectively.

According to a preferred embodiment, the cascode connected output transistor comprises a natural transistor, which is a transistor with a very small threshold voltage Vth. As stated before, the boosted voltage is given by the following equation
Vout2=Vgate−Vth.
Thus, it is desirable to use a natural transistor if a boosted voltage Vout2 with the largest possible value is desired. Preferably, the cascode connected transistor comprises a high-voltage transistor, because it may withstand voltages larger than the supply voltage of the generator.

According to an alternative embodiment, the current terminal of the output transistor CASCODE coupled to the voltage Vout1, may be coupled to the voltage output by any intermediate stage of the charge pump.

A second embodiment of the generator is depicted in FIG. 5. Different from the generator of FIG. 1, it has a switch HV SWITCH for connecting the control node of the cascode connected transistor to any intermediate stage of the multi-stage charge pump. An advantage of this architecture is that it is possible to vary the generated boosted voltage according to the needs.

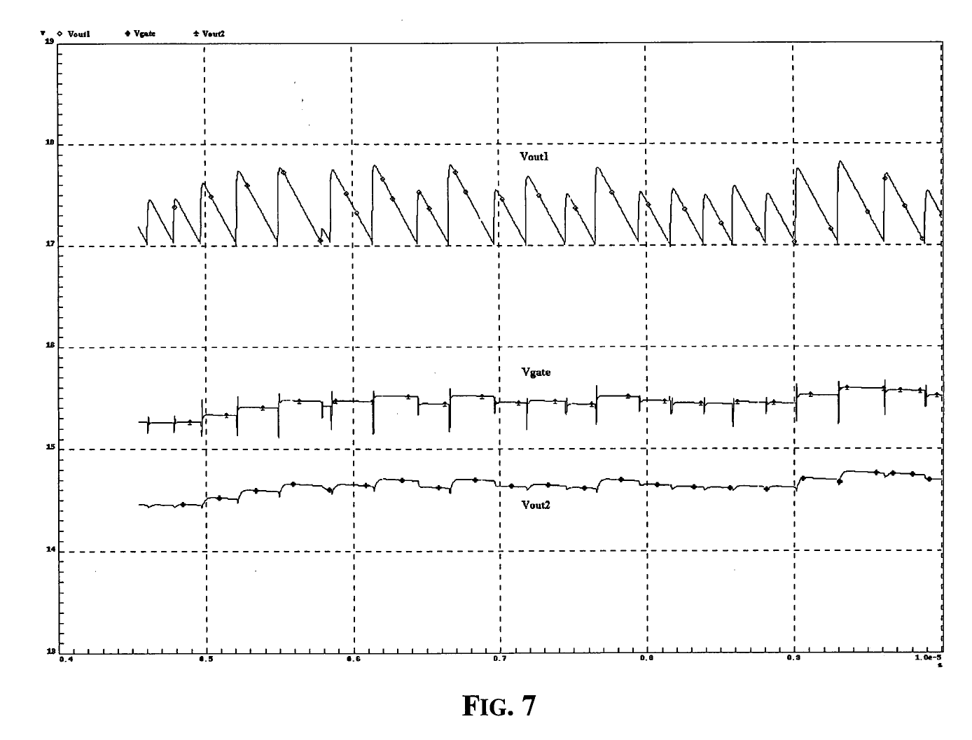

An alternative embodiment to the architecture of FIG. 5 is that depicted in FIG. 6. FIG. 6 comprises a plurality of cascode connected transistors each controlled by the voltage on a respective intermediate node of the charge pump, and each generating a respective output boosted voltage. The same considerations and variations that may be carried out with the architecture of FIG. 1 may also apply also for the embodiments of FIGS. 5 and 6.

The time diagrams of FIG. 7, obtained by simulating the functioning of the generator of FIG. 1, wherein all the stages are as depicted in FIG. 2, show the generated boosted voltage Vout2 is affected by a smaller ripple than the controlled voltage Vout1 generated by the charge pump.

1-12. (canceled)

13. A generator for a boosted voltage comprising:
an output node for the boosted voltage;
a charge pump comprising a last stage generating a first control voltage at an output thereof; and
a cascode coupled output transistor having first and second conduction terminals coupled to said charge pump and to said output node respectively, and a control terminal coupled to a second control voltage being less corrupted by ripple than the first control voltage and that maintains said cascode coupled output transistor in a conduction state.

14. The generator according to claim 13 wherein the first conduction terminal is coupled to the output of the last stage of said charge pump.

15. The generator according to claim 13 wherein said charge pump comprises a multi-stage charge pump including a plurality of stages coupled in series; and wherein the control terminal of said cascode coupled output transistor is coupled between two adjacent stages of said multi-stage charge pump onto which a fraction of the first control voltage is generated.

16. The generator according to claim 13 further comprising a low-pass filter for generating the second control voltage.

17. The generator according to claim 13 wherein said low-pass filter comprises a voltage dividing low-pass filter.

18. The generator according to claim 13 wherein said charge pump comprises a multi-stage charge pump including a plurality of stages coupled together in series; and further comprising at least one other output node and at least one additional cascode coupled output transistor having conduction terminals coupled between the first control voltage and the at least one other output node respectively, and a control terminal coupled to a stage upstream of the last stage.

19. The generator according to claim 13 wherein said charge pump generates a positive boosted voltage with respect to a first reference voltage; and wherein said cascode coupled output transistor comprises an N-channel MOS transistor.

20. The generator according to claim 13 wherein said charge pump generates a negative boosted voltage with respect to a first reference voltage; and wherein said cascode coupled output transistor comprises a P-channel MOS transistor.

21. The generator according to claim 13 wherein said cascode coupled output transistor comprises a natural MOS transistor.

22. The generator according to claim 13 wherein said charge pump comprises a multi-stage charge pump including a plurality of stages coupled together in series; and further comprising a switch for selectively coupling the control terminal of said cascode coupled output transistor between two adjacent stages of said charge pump as a function of a desired boosted voltage to be generated.

23. The generator according to claim 13 wherein said charge pump comprises a multi-stage charge pump including a plurality of stages coupled together in series; and wherein the control terminal of said cascode coupled output transistor is coupled between the last stage and a second-to-last stage.

24. A generator for a boosted voltage comprising:
an output node for the boosted voltage;
a multi-stage charge pump comprising a last stage generating a first control voltage at an output thereof and at least one other stage upstream of the last stage; and
a cascode coupled output transistor having first and second conduction terminals coupled to the first control voltage and to said output node respectively, and a control terminal coupled to a second control voltage between two adjacent stages of said charge pump.

25. The generator according to claim 24 further comprising at least one other output node and at least one additional cascode coupled output transistor having conduction terminals coupled between the first control voltage and the at least one other output node respectively, and a control terminal coupled to a stage upstream of the last stage.

26. The generator according to claim 24 wherein said charge pump generates a positive boosted voltage with respect to a first reference voltage; and wherein said cascode coupled output transistor comprises an N-channel MOS transistor.

27. The generator according to claim 24 wherein said charge pump generates a negative boosted voltage with respect to a first reference voltage; and wherein said cascode coupled output transistor comprises a P-channel MOS transistor.

28. The generator according to claim 24 wherein said cascode coupled output transistor comprises a natural MOS transistor.

29. The generator according to claim 24 further comprising a switch for selectively coupling the control terminal of said cascode coupled output transistor between two adjacent stages of said charge pump as a function of a desired boosted voltage to be generated.

30. The generator according to claim 24 wherein the control terminal of said cascode coupled output transistor is coupled between the last stage and a second-to-last stage.

31. A generator for a boosted voltage comprising:
an output node for the boosted voltage;
a charge pump comprising a last stage generating a first control voltage at an output thereof;
a cascode coupled output transistor having first and second conduction terminals coupled to said charge pump and to said output node respectively, and a control terminal coupled to a second control voltage that maintains said cascode coupled output transistor in a conduction state; and
a low-pass filter for generating the second control voltage.

32. The generator according to claim 31 wherein said low-pass filter comprises a voltage dividing low-pass filter.

33. The generator according to claim 31 wherein said charge pump generates a positive boosted voltage with respect to a first reference voltage; and wherein said cascode coupled output transistor comprises an N-channel MOS transistor.

34. The generator according to claim 31 wherein said charge pump generates a negative boosted voltage with respect to a first reference voltage; and wherein said cascode coupled output transistor comprises a P-channel MOS transistor.

35. The generator according to claim 31 wherein said cascode coupled output transistor comprises a natural MOS transistor.

36. A method for reducing ripple of a boosted voltage generated by a generator comprising an output node for the boosted voltage, a charge pump comprising a last stage generating a first control voltage at an output thereof, and a cascode coupled output transistor having first and second conduction terminals coupled to the charge pump and to the output node respectively, and a control terminal, the method comprising:
coupling the control terminal of the cascode coupled output transistor to a second control voltage being less corrupted by ripple than the first control voltage and that maintains the cascode coupled output transistor in a conduction state.

37. The method according to claim 36 wherein the first conduction terminal is coupled to the output of the last stage of the charge pump.

38. The method according to claim 36 wherein the charge pump comprises a multi-stage charge pump including a plurality of stages coupled in series; and wherein the control terminal of the cascode coupled output transistor is coupled between two adjacent stages of the multi-stage charge pump onto which a fraction of the first control voltage is generated.

39. The method according to claim 36 further comprising generating the second control voltage using a low-pass filter.

40. The method according to claim 39 wherein the low-pass filter comprises a voltage dividing low-pass filter.

41. The method according to claim 36 wherein the charge pump comprises a multi-stage charge pump including a plurality of stages coupled together in series; and wherein the generator further comprises at least one other output node and at least one additional cascode coupled output transistor having conduction terminals coupled between the first control voltage and the at least one other output node respectively, and a control terminal; and further comprising coupling the control terminal of the at least one additional cascode coupled output transistor to a stage upstream of the last stage.

42. The method according to claim 36 wherein the charge pump comprises a multi-stage charge pump including a plurality of stages coupled together in series; and further comprising selectively coupling the control terminal of the cascode coupled output transistor between two adjacent stages of the charge pump as a function of a desired boosted voltage to be generated.

43. The method according to claim 36 wherein the charge pump comprises a multi-stage charge pump including a plurality of stages coupled together in series; and wherein the control terminal of the cascode coupled output transistor is coupled between the last stage and a second-to-last stage.
